(19) United States
(12) Patent Application Publication
(10) Pub. No.: US 2009/0300182 A1
(43) Pub. Date: Dec. 3, 2009

(54) COMPUTER-READABLE STORAGE MEDIUM STORING EVENT CONTROL PROGRAM, EVENT CONTROL METHOD, AND EVENT CONTROLLER

(75) Inventors: Hitoshi Ueno, Kawasaki (JP); Kouichirou Amemiya, Kawasaki (JP); Masaaki Takase, Kawasaki (JP); Kenichi Abiru, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/415,527

(22) Filed: Mar. 31, 2009

(30) Foreign Application Priority Data
Jun. 3, 2008 (JP) 2008-145360

(51) Int. Cl. G06F 15/173

(52) U.S. Cl. 709/226

(57) ABSTRACT

An event controller is caused to function as a receiving unit, a request unit, and a transfer unit. The receiving unit receives an event notification request containing designation information designating a client. The request unit requests notification of one of a plurality of servers as an assignment destination server, based on the designation information, the one providing a service to the client identified by the designation information. The transfer unit transfers the event notification request to the assignment destination server notified in response to the request by the request unit.

### CROSS-REFERENCE TO RELATED APPLICATIONS

This application is based upon and claims the benefit of priority of the prior Japanese Patent Application No. 2008-145360, filed on Jun. 3, 2008, the entire contents of which are incorporated herein by reference.

### FIELD

The embodiments discussed herein are related to a computer-readable storage medium storing an event control program, an event control method, and an event controller.

### BACKGROUND

Recently, there has been an increase in needs for providing a service on the Web by an application having a distinctive feature easily by combining services using a plurality of protocols, such as an HTTP (HyperText Transfer Protocol) and an SIP (Session Initiation Protocol).

For example, a service is known which changes response information to an HTTP request from a Web browser, based on SIP Notify information from a presence server.

In such a service, to prevent a decrease in the processing speed of a server and interruption of the service from being caused by an increase in the number of users of the service, it is a general practice to distribute load using a plurality of servers.

FIG. 23 illustrates a system for performing load distribution.

The system illustrated in FIG. 23 includes a server load balancer (SLB) 91, a presence server 92, clients 93a and 93b, and Web servers 94a and 94b.

The server load balancer 91 has the function of sequentially assigning HTTP requests from the clients 93a and 93b to the Web servers 94a and 94b so as to distribute load on Web applications for the clients 93a and 93b.

Once a session is established between one of the clients and one of the Web servers, the server load balancer 91 assigns HTTP requests from the client to the Web server which has established the session with the client, for a predetermined time period.

The presence server 92 subscribes to (registers in advance) notification of state changes (state change events) in response to notification requests from the respective Web servers 94a and 94b necessitating presence information.

After that, upon detection of a state change requesting notification thereof, the presence server 92 transfers a Notify message (message for notification of the state change) to the Web servers 94a and 94b (for which the presence server 92 has subscribed).

Thus, when a session is established e.g. between the client 93a and the Web server 94a, HTTP requests from the client 93a are assigned to the Web server 94a by the server load balancer 91.

On the other hand, the Notify message generated by the presence server 92 is transmitted to all the subscribed Web servers 94a and 94b.

As a consequence, the Notify message is transferred also to the Web server 94b which is not accessed by HTTP by the client 93a.

Normally, a Web server having received a Notify message executes processing (e.g. database search and preparation of screen data) based on tag information stored in the Notify message. This means that a Web server (the Web server 94b in the example illustrated in FIG. 23) which is not accessed by HTTP by a client, performs useless processing.

In this connection, a technique is known in which when the state of an object is not changed during subscription, an empty Notify message is transmitted to thereby reduce network load. (see e.g. Japanese Laid-Open Patent Publication No. 2007-26006)

However, in such a case as well, the Notify message is transferred to the Web servers, which makes it impossible to reduce load on the servers.

### SUMMARY

According to an aspect of the embodiments, an event controller that carries out relay control of events comprises a receiving unit configured to receive an event notification request containing designation information designating a client, a request unit configured to request notification of one of a plurality of servers as an assignment destination server, based on the designation information, the one providing a service to the client identified by the designation information; and a transfer unit configured to transfer the event notification request to the assignment destination server notified in response to the request by the request unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a general diagram of a computer system according to embodiments of the present invention;

FIG. 2 illustrates a configuration of a network system;

FIG. 3 illustrates an assignment destination management table;

FIG. 4 illustrates a subscription management table;

FIG. 5 illustrates a group management table;

FIG. 6 is a sequence diagram of a process performed by the network system;

FIG. 7 illustrates an example of the hardware configuration of a Notify controller;

FIG. 8 is a functional block diagram of the Notify controller;

FIG. 9 is a flowchart of a process performed by the Notify controller;

FIG. 10 is a sequence diagram of an example of the process performed by the network system;

FIG. 11 is a flowchart of a process performed by an HTTP load balancer;

FIG. 12 illustrates an example in which the functions of the Notify controller are implemented on an apparatus other than the Notify controller;

FIG. 13 illustrates another example in which the functions of the Notify controller are implemented on an apparatus other than the Notify controller;

FIG. 14 is a functional block diagram of a Notify controller according to a second embodiment of the present invention;

FIG. 15 illustrates a to-be-handled server list;

FIG. 16 is a flowchart of a process performed by the Notify controller according to the second embodiment;

FIG. 17 illustrates an assignment destination management table for use in a third embodiment of the present invention;

FIG. 18 is a functional block diagram of a Notify controller according to the third embodiment;

FIG. 19 is a flowchart of a process performed by the Notify controller according to the third embodiment;

FIG. 20 is a block diagram of a Notify controller according to a fourth embodiment of the present invention;

FIG. 21 illustrates a user use state management table included in an authentication server;

FIG. 22 is a flowchart of a process performed by the Notify controller according to the fourth embodiment; and

FIG. 23 illustrates a system for performing load distribution.

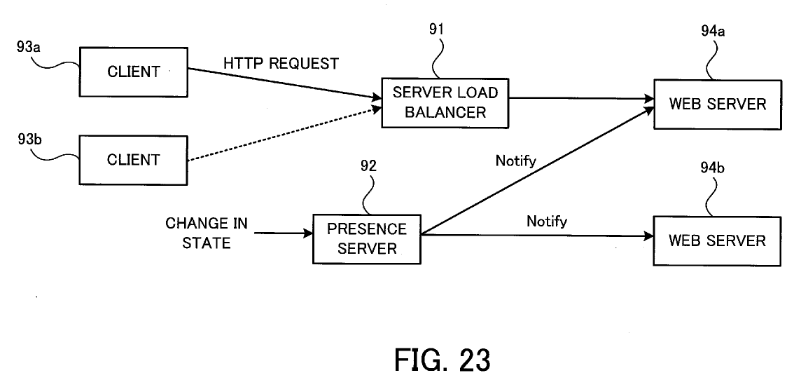

### DESCRIPTION OF EMBODIMENT(S)

Embodiments of the present invention will be explained below with reference to the accompanying drawings, wherein like reference numerals refer to like elements throughout.

First, a description will be given of the outline of a computer system according to the embodiments, and then of more details of the embodiments.

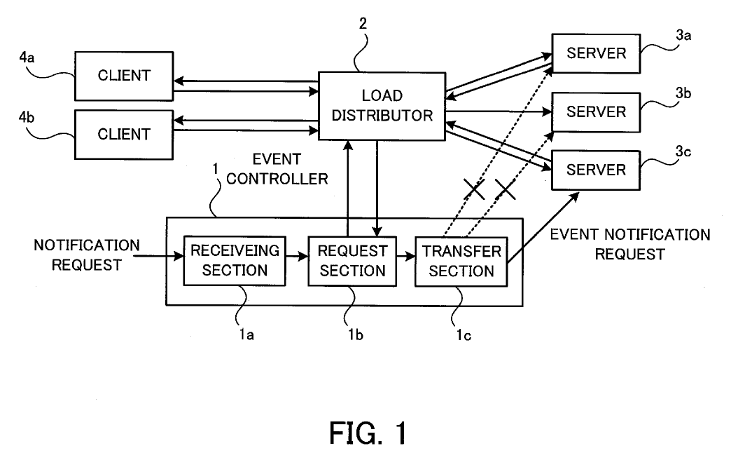

FIG. 1 is a general diagram of the computer system according to the embodiments.

An event controller 1 is connected to a load distributor 2 and servers 3a to 3c via a network.

The load distributor 2 dynamically assigns data-processing requests from clients 4a and 4b which perform data communication with the servers 3a to 3c by a predetermined protocol (e.g. HTTP), to the servers 3a to 3c. In doing this, the load distributor 2 stores the relations between the servers determined as assignment destinations and the clients, respectively, such that the relations can be known, and assigns data-processing requests from the clients to the associated ones of the servers based on the above-mentioned relations, during a time period over which each session is established.

Referring to FIG. 1, the load distributor 2 determines to assign data-processing requests from the client 4a to the server 3c, and stores the relation therebetween, and also determines to assign data-processing requests from the client 4b to the server 3a, and stores the relation therebetween, by way of example.

The servers 3a to 3c provide predetermined services in response to the requests from the clients 4a and 4b, respectively.

The event controller 1 includes a receiving section 1a, a request section 1b, and a transfer section 1c.

The receiving section 1a receives event notification requests each including designation information for designating the client 4a or 4b. The event notification requests are transmitted by a protocol (e.g. SIP) different from the predetermined server-client protocol.

As the designation information, there may be mentioned, for example, a client IP address for directly designating a client, an ID of a user who has logged in to a client, which is used for indirectly designating the client, an ID of a tag provided in a manner associated with a client, and so forth.

Further, the event notification request is for requesting events to be notified to a server which has subscribed in advance to notification of events.

Based on the designation information included in an event notification request received by the receiving section 1a, the request section 1b requests the load distributor 2 to notify one of the servers 3a to 3c which is providing a service for a client identified by the designation information, as an assignment destination server.

The load distributor 2 determines an assignment destination server based on the information stored in advance, and notifies the event controller 1 of the determined assignment destination server in response.

The transfer section 1c transfers the event notification request to the assignment destination server notified in response to the request from the request section 1b by a protocol different from the predetermined server-client protocol.

For example, when the transfer section 1c is notified by the load distributor 2 that the server 3c is the assignment destination, the transfer section 1c transfers the notification request only to the server 3c, but not to the servers 3a and 3b.

In response to the event notification request, the server 3c (which is in communication with the client 4a) executes processing of an event and responds to the client 4a.

As described above, the event controller 1 transfers a notification request to one of the servers 3a to 3c, which is determined as an assignment destination, but not to the other servers, and hence the other servers need not perform useless processing, which makes it possible to reduce processing load on the other servers.

Hereinafter, a more detailed description will be given of the embodiments.

### [a] First Embodiment

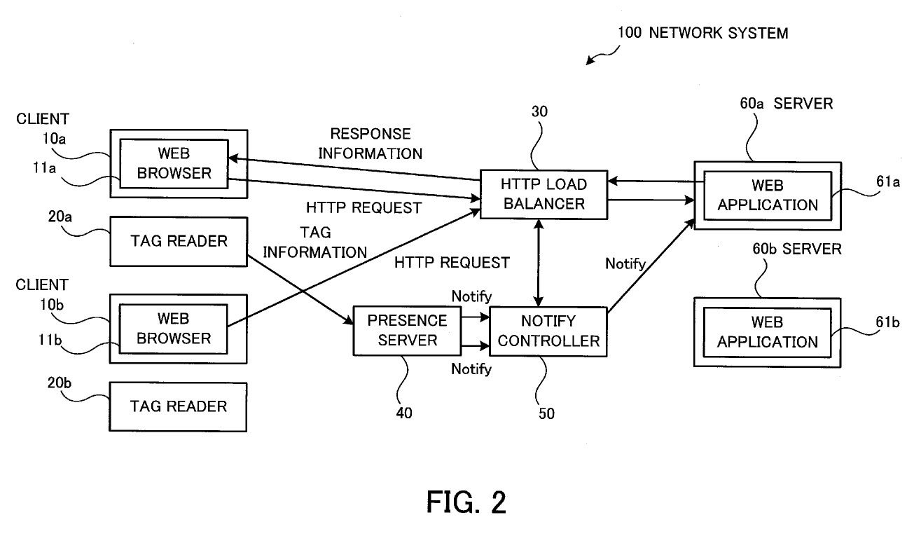

FIG. 2 illustrates the configuration of a network system.

The network system 100 includes clients 10a and 10b, tag readers 20a and 20b, an HTTP load balancer (server load balancer) 30, a presence server 40, a Notify controller 50, and servers 60a and 60b.

Networks connect between the clients 10a and 10b and the HTTP load balancer 30, between the tag readers 20a and 20b and the presence server 40, between the presence server 40 and the Notify controller 50, and between the Notify controller 50, the HTTP load balancer 30, and the servers 60a and 60b. These networks may be discrete, or alternatively partially or wholly overlap each other.

Now, communication control by HTTP is carried out between the clients 10a and 10b, the HTTP load balancer 30, and the servers 60a and 60b. Further, communication control by SIP is carried out between the HTTP load balancer 30 and the Notify controller 50, and between the presence server 40, the Notify controller 50, and the servers 60a and 60b. Further, the protocol between the tag readers 20a and 20b and the presence server 40 is not particularly limited, but communication control by a desired protocol is carried out.

The clients 10a and 10b are devices by which users make use of (receive) services provided by the servers 60a and 60b, respectively.

A mouse and a keyboard (neither of which is illustrated) are connected to each of the clients 10a and 10b, and Web browsers 11a and 11b are started on monitors (not illustrated) connected to the respective clients 10a and 10b in response to signals delivered according to users' operations of the mice and the keyboards (hereinafter simply referred to as “user operations”).

Then, when the clients 10a and 10b accept requests for causing predetermined screens to be displayed on the Web browsers 11a and 11b by the user operations, respectively, the clients 10a and 10b output HTTP requests to the HTTP load balancer 30.

The tag readers 20a and 20b are provided in a manner associated with the clients 10a and 10b, respectively. In FIG. 2, the tag reader 20a is provided in the vicinity of the client 10a, while the tag reader 20b is provided in the vicinity of the client 10b.

The respective tag readers 20a and 20b have the functions of reading tags (tags incorporated e.g. in mobile terminals and cards) existing within predetermined areas, and transmit tag information formed by adding predetermined information to contents read in, to the presence server 40.

The contents read in include e.g. user IDs for identifying users who have logged in to the clients 10a and 10b. Further, the predetermined information added to the contents read in includes e.g. identification information on the tag readers 20a and 20b.

Next, a description will be given of an example of how the above-described network system 100 is used.

When the user who operates the client 10a desires to receive a particular service provided by a Web application 61a during browsing using the browser 11a, the user causes the tag reader 20a to read a tag. This causes the presence server 40 and the Notify controller 50 to perform processing, described hereinafter, whereby a Notify message is transmitted to the server 60a. The Web application 61a of the server 60a executes processing on the Notify message, and returns response information to the browser 11a. This enables the user to receive the particular service.

The HTTP load balancer 30 relays between the clients 10a and 10b, and the servers 60a and 60b.

Upon reception of an HTTP request from the client 10a or 10b, the HTTP load balancer 30 determines the server 60a or 60b which the HTTP load balancer 30 causes to process the HTTP request (as an assignment destination), whereby the HTTP request is dynamically assigned to the determined one of the servers 60a or 60b.

The HTTP load balancer 30 associates the client that transmitted the HTTP request and the server to which the HTTP request from the client is assigned, and stores the association in an assignment destination management table (described hereinafter).

After that, upon reception of an HTTP request, the HTTP load balancer 30 refers to the assignment destination management table to thereby assign the HTTP request to the server associated with the client that has issued the HTTP request.

It should be noted that FIG. 2 illustrates a case in which the HTTP request made by the client 10a is assigned to the server 60a.

Further, upon reception of a response to the HTTP request from the server 60a or 60b as the assignment destination, the HTTP load balancer 30 sends the response to the client 10a or 10b that transmitted the HTTP request. In the case illustrated in FIG. 2, the HTTP load balancer 30 receives a response to the HTTP request from the server 60a, and sends the response to the client 10a that transmitted the HTTP request.

Further, upon reception of an inquiry concerning a server as an assignment destination of a Notify message, from the Notify controller 50, the HTTP load balancer 30 performs processing, described hereinafter, to thereby identify the assignment destination server, and sends a response to the Notify controller 50.

The presence server 40 has an IP address of the Notify controller 50 set in advance as a first transfer destination of the received tag information. This causes all pieces of tag information received by the presence server 40 to be transmitted to the Notify controller 50 without being directly transmitted to a server set forth as a transmission destination of the received tag information.

Upon reception of the tag information from the tag reader 20a or 20b, the presence server 40 refers to a subscription management table (described hereinafter) to thereby identify a server as a subscriber (entity which requests notification of events) and transmits a Notify message to be transmitted to the server, to the Notify controller 50. This Notify message contains tag information.

If there is a plurality of servers as subscribers, the presence server 40 transmits a Notify message to an associated one of these servers.

Upon reception of the Notify message from the presence server 40, the Notify controller 50 inquires of the HTTP load balancer 30 as to an assignment destination of the Notify message. More specifically, in inquiring the HTTP load balancer 30 as to the assignment destination of the Notify message, the Notify controller 50 refers to a group management table (described hereinafter) prepared in advance to thereby identify a client that necessitates response information, and inquires as to the assignment destination based on the IP address of the identified client.

By inquiring as to the assignment destination, the Notify controller 50 determines the server 60a or 60b as a transfer destination of the received Notify message.

In the case illustrated in FIG. 2, the client 10a is identified. As described hereinabove, since the HTTP load balancer 30 assigns the HTTP request transmitted from the client 10a to the server 60a, the Notify controller 50 is notified by the HTTP load balancer 30 that the server 60a is the assignment destination, and determines the server 60a as the assignment destination.

After that, the Notify controller 50 determines whether or not the Notify message may be transmitted to the server determined as the assignment destination. If it is determined that the Notify message may be transmitted to the server determined as the assignment destination, the Notify controller 50 transfers the Notify message to the server.

The servers 60a and 60b have the functions of executing the Web applications 61a and 61b according to requests from the Web browsers 11a and 11b. Upon reception of an HTTP request from the HTTP load balancer 30, an associated one of the servers 60a and 60b executes one of the Web applications 61a and 61b according to the HTTP request, and transmits a file (HTML file or the like) as a result of execution of the Web application to the HTTP load balancer 30.

Further, upon reception of the Notify message from the Notify controller 50, the one of the servers 60a and 60b determined as the assignment destination executes processing according to information contained in the Notify message, causes response information to be contained in a response to the HTTP request, and transmits the response to the identified client.

Next, a description will be given of the assignment destination management table provided in the HTTP load balancer 30.

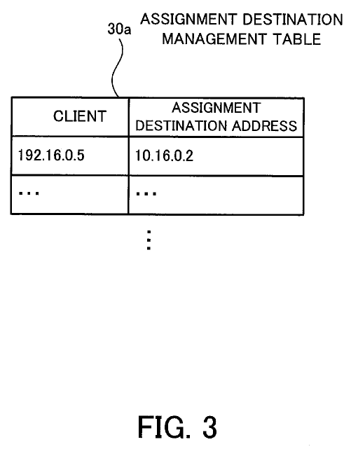

FIG. 3 illustrates the assignment destination management table.

The assignment destination management table 30a includes the columns of “CLIENT” and “ASSIGNMENT DESTINATION ADDRESS, and pieces of information arranged in each row in the table are associated with each other.

The column of “CLIENT” stores IP addresses (identification information) of clients as senders of HTTP requests received by the HTTP load balancer 30.

In FIG. 3, the IP address “192.16.0.5” of the client 10a is stored in a box of the column of “CLIENT”.

The column of “ASSIGNMENT DESTINATION ADDRESS” stores IP addresses each for identifying a server with which a client having an IP address stored in the associated box of the column of “CLIENT” has established a session.

In FIG. 3, the IP address “10.16.0.2” of the server 60a is stored in a box of the column of “ASSIGNMENT DESTINATION ADDRESS”.

Next, a description will be given of the subscription management table included in the presence server 40.

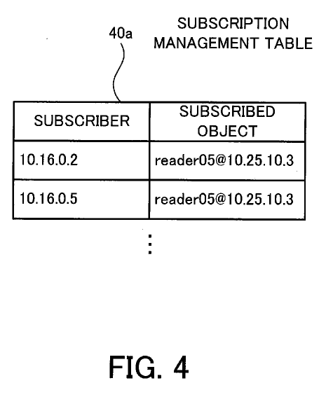

FIG. 4 illustrates the subscription management table.

The subscription management table 40a has columns of “SUBSCRIBER” and “SUBSCRIBED OBJECT”, and pieces of information arranged in each row in the table are associated with each other.

The column of “SUBSCRIBER” stores IP addresses of servers as senders of subscriptions.

In FIG. 4, the IP address “10.16.0.2” of the server 60a, and the IP address “10.16.0.5” of the server 60b are stored in respective boxes of the column of “SUBSCRIBER”.

A URI (Uniform Resource Identifier) of each tag reader as to which a server stored in a box of the column of “SUBSCRIBER” has subscribed (to which the server subscribes) is stored in an associated box of the column of “SUBSCRIBED OBJECT”.

In FIG. 4, a URI “reader05@10.25.10.3” of the tag reader 20a is stored in the column of “SUBSCRIBED OBJECT”.

By referring to the subscription management table 40a, the presence server 40 is capable of recognizing which server subscribes in advance to notification of a change in which tag reader as desired by the server.

Next, a description will be given of the group management table provided in the Notify controller 50.

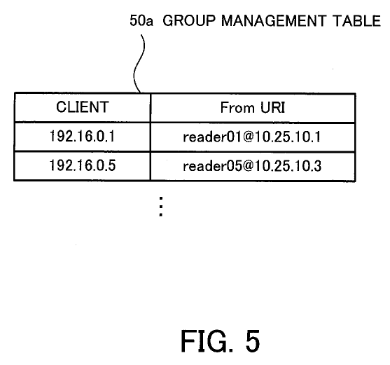

FIG. 5 illustrates the group management table.

The group management table 50a has columns of “CLIENT” and “FROM URI”, and pieces of information arranged in each row in the table are associated with each other.

The column of “CLIENT” stores client IP addresses.

The column of “FROM URI” stores URIs of tag readers.

By referring to this group management table 50a, the Notify controller 50 is capable of recognizing with which client associated tag information is contained in a received Notify message.

Next, a brief description will be given of a process performed by the network system 100.

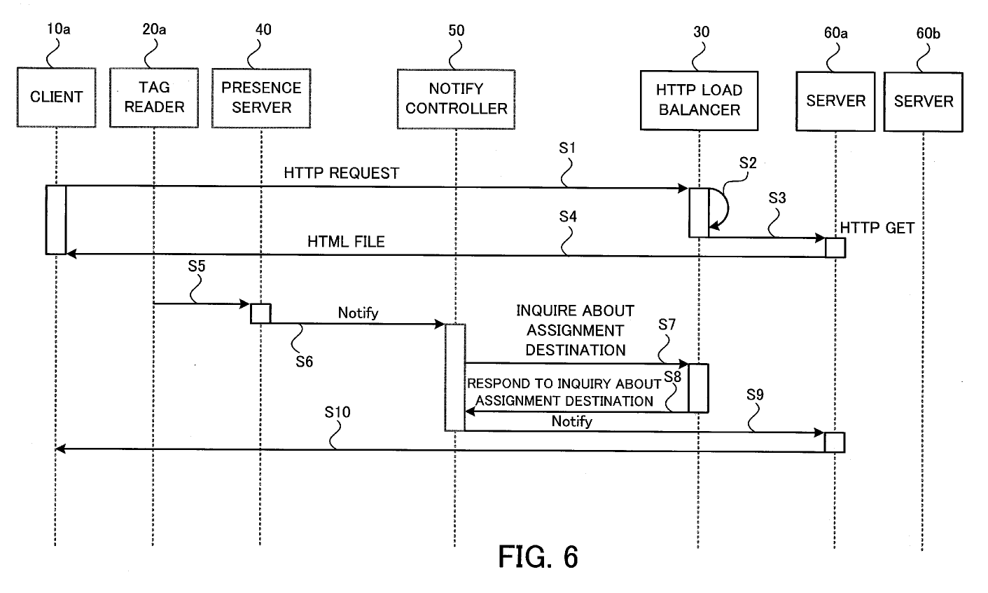

FIG. 6 is a sequence diagram of the process performed by the network system 100.

The servers 60a and 60b transmit SIP respective subscriptions containing information on subscribers and subscribed objects to the presence server 40. The presence server 40 stores the information on the subscribers and subscribed objects contained in the received SIP subscriptions, in the subscription management table 40a. Processing thus far carried out is performed as pre-processing.

After that, the Web browser 11a of the client 10a is started, and an HTTP request is transmitted to the HTTP load balancer 30 (step S1).

The HTTP load balancer 30 determines an assignment destination server according to the HTTP request, and stores an IP address of a client as a sender and an IP address of the determined assignment destination server in the assignment destination management table 30a in association with each other (step S2).

Then, the HTTP load balancer 30 assigns the HTTP request to the assignment destination server (the server 60a in the example illustrated in FIG. 6) (step S3).

The server 60a having the HTTP request assigned thereto sends an HTML files to the client 10a in response to the HTTP request (step S4).

Then, when a tag is put in front of the tag reader 20a, the tag reader 20a transmits tag information to the presence server 40 (step S5).

The presence server 40 transmits a Notify message to be transmitted to a subscriber which is acquired by referring to the subscription management table 40a, to the Notify controller 50 (step S6).

Upon reception of the Notify message, the Notify controller 50 inquires of the HTTP load balancer 30 as to the assignment destination of the Notify message (requests notification of the Notify message destination) (step S7).

The HTTP load balancer 30 refers to the assignment destination management table 30a according to the request from the Notify controller 50, and sends a response of the assignment destination to the Notify controller 50 (step S8).

The Notify controller 50 determines whether or not to transfer the Notify message to the server contained in the response from the HTTP load balancer 30 as the determined assignment destination. If it is determined to transfer the Notify message, the Notify message is transferred to the server as the assignment destination (the server 60a in the example illustrated in FIG. 6). A criterion for determining whether or not to transfer the Notify message will be described hereinafter.

Thus, the Web application 61a of the server 60a executes the application to transmit obtained response information to the client 10a (step S10). As a result, the response information is displayed on a monitor included in the client 10a.

This completes the description of the process performed by the network system 100.

Hereinafter, a detailed description will be given of the configuration of the Notify controller 50.

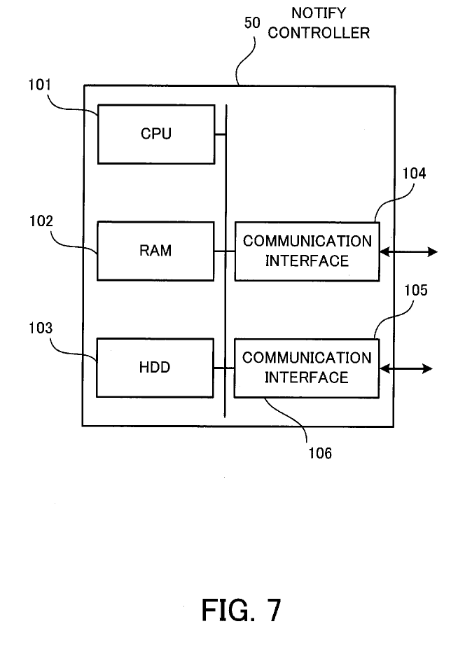

FIG. 7 illustrates an example of the hardware configuration of the Notify controller.

The Notify controller 50 has its overall operation controlled by a CPU (Central Processing Unit) 101. Connected to the CPU 101 are a RAM (Random Access Memory) 102, a hard disk drive (HDD) 103, and communication interfaces 104 and 105, via a bus 106.

The RAM 102 temporarily stores at least part of the programs of an OS (Operating System) and application programs executed by the CPU 101. Further, the RAM 102 stores various kinds of data required for processing by the CPU 101. The HDD 103 stores the OS and the application programs. Further, the HDD 103 stores program files.

The communication interface 104 performs transmission and reception of data to and from the HTTP load balancer 30. The communication interface 105 performs transmission and reception of data to and from the presence server 40 and the servers 60a and 60b.

The hardware configuration described above can realize the processing capabilities of the present embodiment. To carry out the above-described processing by the system configured as above, the Notify controller 50 is provided with the following functions:

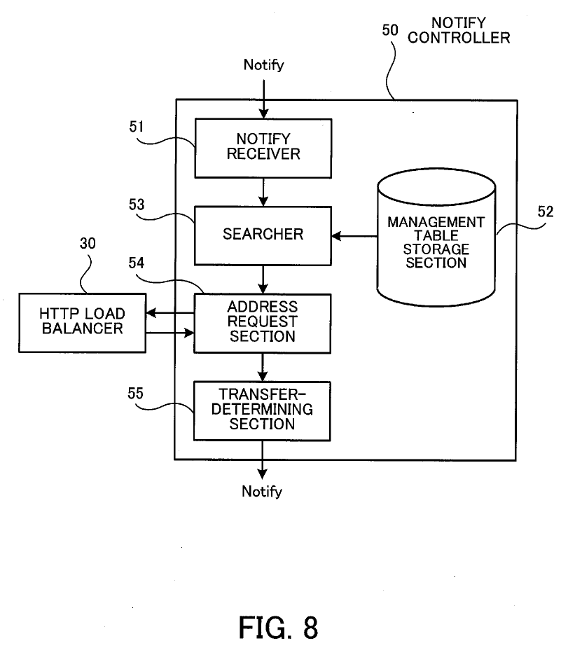

FIG. 8 is a functional block diagram of the Notify controller.

The Notify controller 50 includes a Notify receiver 51, a management table storage section 52, a searcher 53, an address request section 54, and a transfer-determining section 55.

The Notify receiver 51 receives a Notify message from the presence server 40.

The management table storage section 52 stores the group management table 50a. The management table storage section 52 is realized e.g. as a storage area of the HDD 103 or the RAM 102 illustrated in FIG. 7.

The searcher 53 refers to the group management table 50a to search for a client IP address associated with “FROM URI” contained in the Notify message received by the Notify receiver 51, to thereby acquire the IP address.

The address request section 54 inquires of the HTTP load balancer 30 as to an assignment destination of the Notify message based on the IP address acquired by the searcher 53.

Further, the address request section 54 receives a response to the inquiry from the HTTP load balancer 30 and sends the same to the transfer-determining section 55.

The transfer-determining section 55 determines whether or not the Notify message may be transferred to a server determined as the assignment destination of the Notify message. If it is determined that the Notify message may be transferred, the transfer-determining section 55 transfers the Notify message to the assignment destination, whereas if it is not determined that the Notify message may be transferred, the transfer-determining section 55 abandons the Notify message.

Next, a description will be given of a process performed by the Notify controller 50.

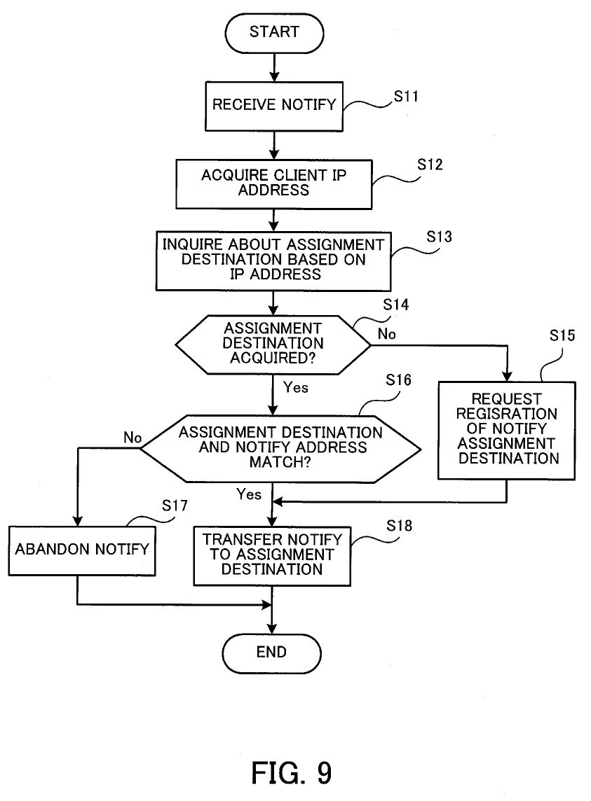

FIG. 9 is a flowchart of the process performed by the Notify controller.

First, the Notify receiver 51 receives a Notify message (step S11).

Then, the searcher 53 refers to the group management table 50a to search for a client IP address associated with “FROM URI” contained in the Notify message that was received by the Notify receiver 51, to thereby acquire the IP address (step S12).

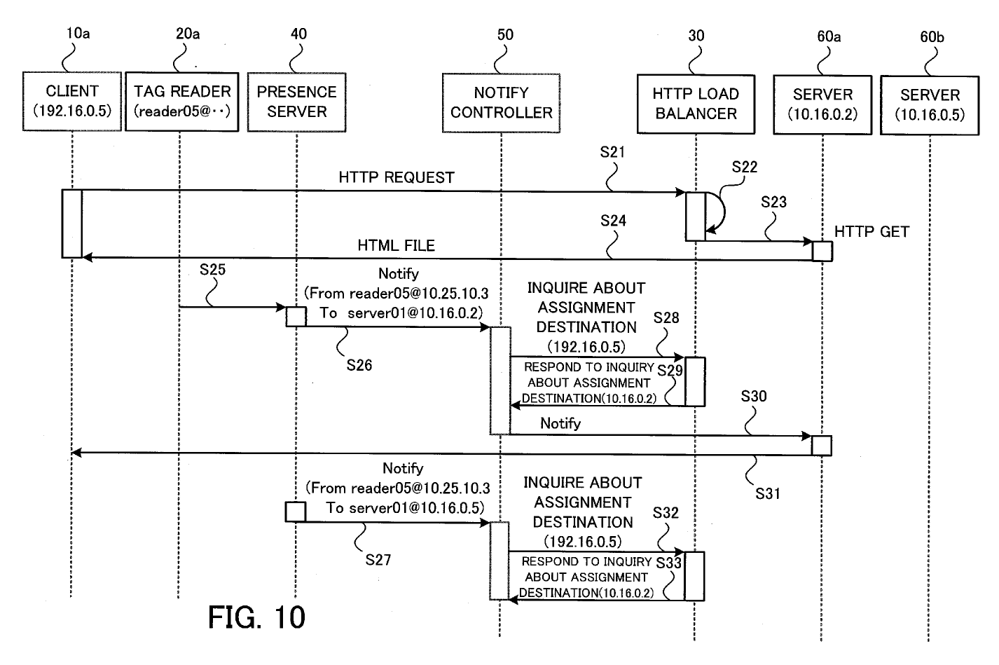

Next, the address request section 54 inquires of the HTTP load balancer 30 as to an assignment destination server (simply denoted as “assignment destination” in the example illustrated in FIG. 9; the same applies to FIG. 10 et. seq.), based on the client IP address acquired by the searcher 53 (step S13).

Next, the transfer-determining section 55 determines whether or not the assignment destination server is acquired from the HTTP load balancer 30 (step S14).

If the assignment destination server is not acquired, i.e. if the assignment destination server associated with the client does not exist in the assignment destination management table 30a (No to step S14), the transfer-determining section 55 requests the HTTP load balancer 30 to register a destination address contained in the Notify message as the assignment destination of the Notify message associated with the client (step S15). After that, the transfer-determining section 55 sets the server designated by the destination address as the assignment destination server and transfers the Notify message to the server designated the destination address (step S18), followed by terminating the present process.

On the other hand, if the assignment destination server can be acquired (Yes to step S14), the transfer-determining section 55 determines whether or not an IP address of the assignment destination server and an IP address of a destination address contained in the Notify message match (step S16).

If they do not match (No to step S16), the received Notify message is abandoned (step S17), followed by terminating the present process.

On the other hand, if they match (Yes to step S16) the transfer-determining section 55 transfers the Notify message to the assignment destination server (step S18) followed by terminating the present process.

This completes the description of the process executed by the Notify controller 50.

Next, a detailed description will be given of an example of the process executed by the network system 100.

In the following example, for processing performed by the HTTP load balancer 30, values stored in the assignment destination management table 30a illustrated in FIG. 3 are used. For processing performed by the presence server 40, values stored in the subscription management table 40a illustrated in FIG. 4 are used. For processing performed by the Notify controller 50, values stored in the group management table 50a illustrated in FIG. 5 are used.

FIG. 10 is a sequence diagram of the example of the process by the network system.

In respective steps S21 to S25, processing similar to the processing in steps S1 to S5 in FIG. 6 is carried out.

The presence server 40 that has received tag information from the tag reader 20a refers to the subscription management table 40a, and identifies a server with the IP address “10.16.0.2” corresponding to the ID “reader05@10.25.10.3” of the tag reader 20a included in the tag information, that is, the server 60a, as a subscriber. Further, the presence server 40 identifies a server with the IP address “10.16.0.5” corresponding to the ID “reader05@10.25.10.3” of the tag reader 20a included in the tag information, that is, the server 60b, as a subscriber.

Then, the presence server 40 identifies a Notify message having “FROM URI” set to “reader05@10.25.10.3” and “TO URI” set to “server01@10.16.0.2”, as a Notify message to the server 60a.

Further, the presence server 40 identifies a Notify message having “FROM URI” set to “reader05@10.25.10.3” and “TO URI” set to “server01@10.16.0.5”, as a Notify message to the server 60b.

Then, the presence server 40 transmits the above Notify messages to the Notify controller 50 (steps S26 and S27).

In the following, for purposes of ease of understanding, first, a description will be given of a process performed when the Notify message is transmitted to the Notify controller 50 in the step S26. Next, a description will be given of a process performed when the Notify message is transmitted to the Notify controller 50 in the step S27. It is to be understood that the order of the processes is not particularly limited.

When the Notify receiver 51 receives the Notify message in a step S26, the searcher 53 refers to the group management table 50a, and identifies a client with the IP address “192.16.0.5” corresponding to “FROM URI” of “reader05@10.25.10.3” contained in the Notify message, i.e. the client 10a.

Then, the address request section 54 inquires of the HTTP load balancer 30 as to an assignment destination associated with the client 10a (step S28).

The HTTP load balancer 30 having received the request refers to the assignment destination management table 30a.

Now, the IP address “10.16.0.2” of the assignment destination associated with the client 10a with the IP address “192.16.0.5” exists in the assignment destination management table 30a, and hence the HTTP load balancer 30 returns the IP address “10.16.0.2” of the assignment destination to the Notify controller 50 as a response (step S29).

Since the IP address of the assignment destination server is thus acquired, the transfer-determining section 55 determines whether or not the IP address of the assignment destination server and the destination address of the Notify message match.

In the illustrated example, since the IP address “10.16.0.2” of the assignment destination server and the IP address “10.16.0.2” of “TO URI” of the Notify message match, the transfer-determining section 55 delivers the Notify message to the server with the IP address “10.16.0.2”, i.e. the server 60a (step S30).

In response to this, the server 60a executes an application associated with information (body of a SIP request) contained in the Notify message, and transmits the results of execution of the application (step S31) to the client 10a.

On the other hand, when the Notify receiver 51 receives the Notify message in the step S27, the searcher 53 and the address request section 54 perform processing similar to the processing in the steps S28 to S29 (steps S32 and S33).

Then, the transfer-determining section 55 determines whether or not the IP address of the assignment destination server and the destination address of the Notify message match.

In the illustrated example, since the IP address “10.16.0.2” of the assignment destination server and the IP address “10.16.0.5” of “TO URI” of the Notify message do not match, the transfer-determining section 55 abandons the received Notify message.

As described above, according to the network system 100, the Notify controller 50 transfers a Notify message only to a destination address that matches the IP address of an assignment destination server, and abandons a Notify message the destination address of which does not match the IP address of an assignment destination server. Therefore, no Notify message is transferred to a server which is stored in the subscription management table 40a but which is not responsible for current processing. This makes it possible to avoid useless processing by the servers.

Further, since the Notify controller 50 cooperates with the HTTP load balancer 30 to reduce useless transfer of Notify messages, it is possible to apply the network system also to a system using a plurality of protocols.

Further, when it is impossible to acquire an assignment destination server, the Notify controller 50 is configured to request the HTTP load balancer 30 to register a destination address contained in the Notify message to transfer the current Notify message to the destination address. Therefore, e.g. when a session is not established between the client 10a and the server 60a, even if the user has caused the tag reader 20a to read tag information, the tag information is reliably transferred to the Web application 61a of an assignment destination server. After the session is established between the client 10a and the server 60a, response information is transmitted to the Web browser 11a.

This makes it possible to avoid useless processing by the assignment destination server, for example, whichever of the Web browsers 11a and 11b and the tag readers 20a and 20b may operate earlier.

Although in the present embodiment, when a client having issued an HTTP request is not registered in the HTTP load balancer 30, the address request section 54 of the Notify controller 50 requests the HTTP load balancer 30 to register an assignment destination of a Notify message, this is not limitative, but the HTTP load balancer 30 may be configured to determine the assignment destination and notify the determined assignment destination to the address request section 54. Hereinafter, a detailed description will be given of this configuration.

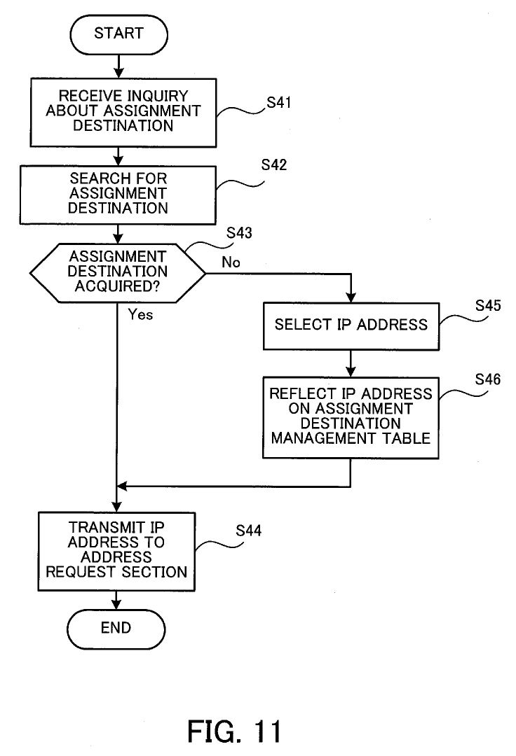

FIG. 11 is a flowchart of a process by the HTTP load balancer.

First, the HTTP load balancer 30 receives an inquiry concerning an assignment destination from the address request section 54 (step S41).

Next, the HTTP load balancer 30 refers to the assignment destination management table 30a to search for an assignment destination server based on a client IP address contained in the inquiry (step S42).

Then, the HTTP load balancer 30 determines whether or not the assignment destination server is acquired (step S43).

If the assignment destination server is acquired (Yes to step S43), the HTTP load balancer 30 transmits an IP address of the acquired assignment destination server to the address request section 54 (step S44).

On the other hand, if the assignment destination server is not acquired (No to step S43), the HTTP load balancer 30 selects one IP address of a desired server as the assignment destination (step S45). The method of this selection is not particularly limited, but as the method, there may be mentioned, for example, one in which a list storing IP addresses of servers to which HTTP requests can be assigned is prepared in advance, and IP addresses are sequentially selected from the top of the list, and one in which IP addresses are randomly selected from the list.

Next, the selected server IP address is reflected on (stored in) the assignment destination management table 30a in association with the IP address of the client contained in the inquiry (step S46).

Then, the process proceeds to a step S44, wherein the selected IP address of the assignment destination server is transmitted to the address request section 54.

This completes the description of the process.

By executing the above described process, the management (configuration) of the assignment destination management table 30a is carried out in a closed manner within the HTTP load balancer 30, which makes it possible to facilitate the management.

Further, although in the present embodiment, the description has been given by causing a separate apparatus (the Notify controller 50) to have the functions of the Notify controller 50, this is not limitative, but another apparatus on the network system 100 may be caused to have the functions of the Notify controller 50, by way of example.

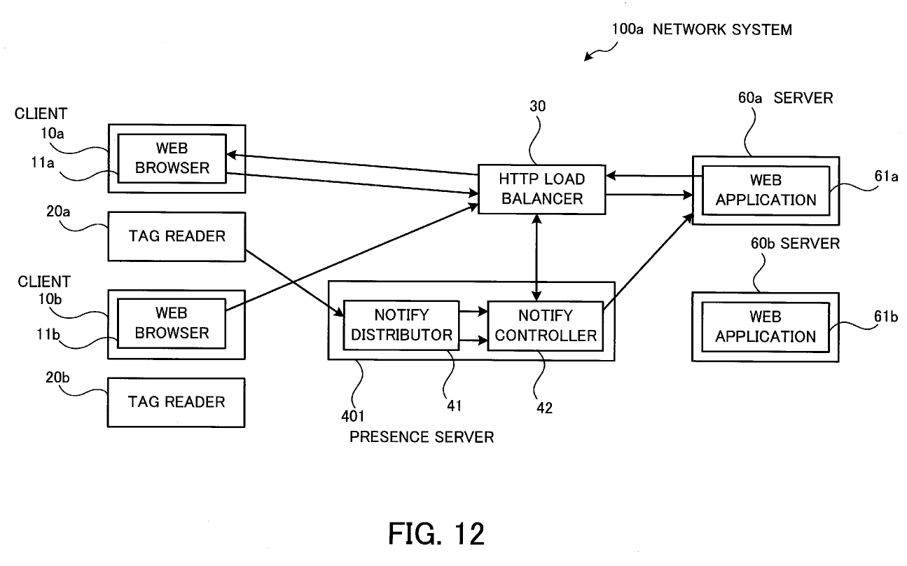

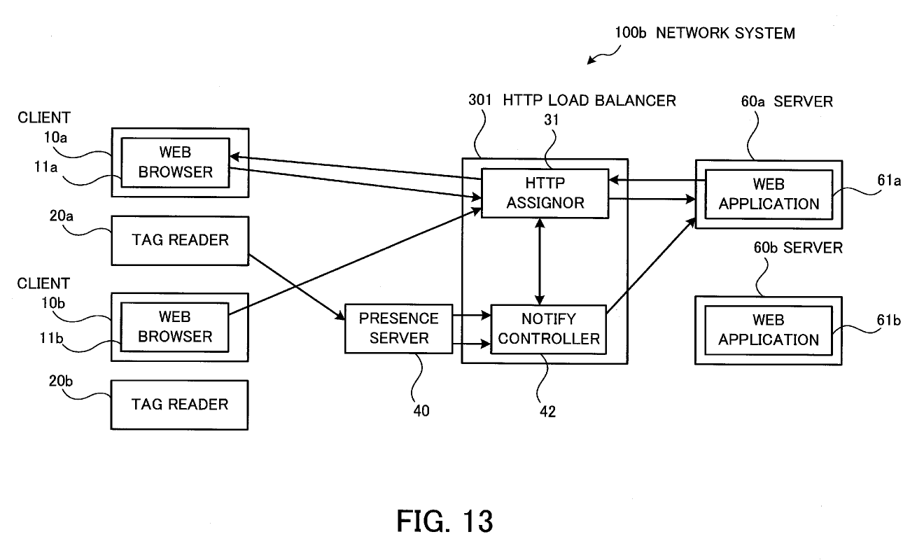

FIGS. 12 and 13 illustrate examples in which the functions of the Notify controller are mounted on another apparatus.

In a network system 100a illustrated in FIG. 12, a presence server 401 includes a Notify distributor 41 that has the same functions as those of the presence server 40, and a Notify controller section 42 that has the same functions as those of the Notify controller 50.

In a network system 100b illustrated in FIG. 13, an HTTP load balancer 301 includes an HTTP assignor 31 that has the same functions as those of the HTTP load balancer 30, and the Notify controller section 42.

The network systems 100a and 100b illustrated in FIGS. 12 and 13 as well can provide the same advantageous effects as provided by the network system 100. Further, according to these system configurations, it is possible to reduce the size of the network system.

Further, although in the present embodiment, the description has been given of the network systems that use the HTTP and the SIP, the present embodiment can be applied to any suitable network system, insofar as it uses a plurality of protocols, irrespective of the types of protocols used therein. For example, the present embodiment can be applied to a system that uses SOAP (Simple Object Access Protocol), SMTP (Simple Mail Transfer Protocol), RTP (Real-time Transport Protocol)/RTCP (RTP Control Protocol), and so forth.

### [b] Second Embodiment

Next, a description will be given of a network system according to a second embodiment.

In the following, a description will be mainly given of different points from the first embodiment, and description of elements identical or similar to those described in the first embodiment is omitted.

The network system according to the second embodiment enables servers that necessitate Notify messages and servers that do not necessitate any Notify messages to mixedly exist therein, and is provided with a Notify controller 501 in place of the Notify controller 50.

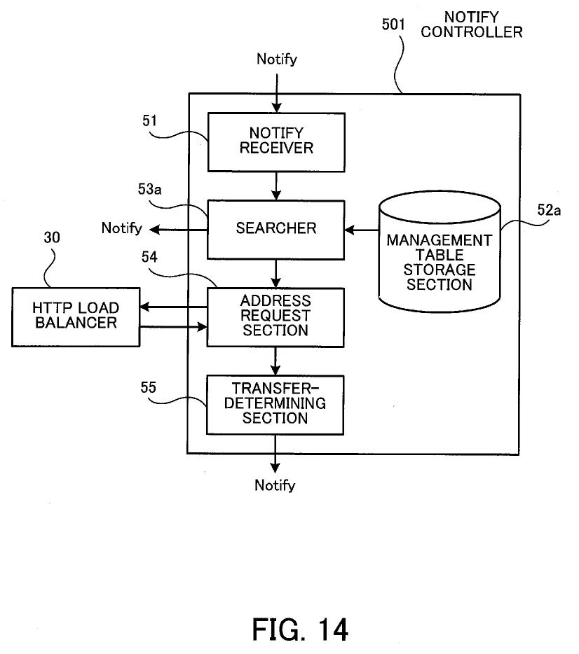

FIG. 14 is a functional block diagram of the Notify controller according to the second embodiment.

The Notify controller 501 is distinguished from the Notify controller 50 in that it includes a management table storage section 52a and a searcher 53a.

The management table storage section 52a includes a to-be-handled server list in addition to the group management table 50a.

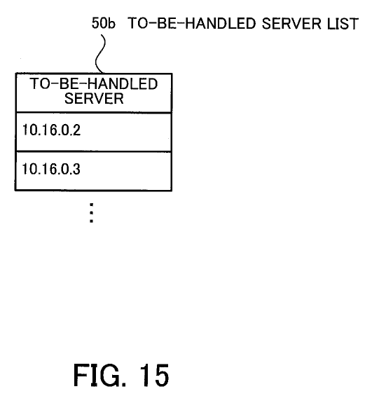

FIG. 15 illustrates the to-be-handled server list.

The to-be-handled server list 50b stores IP addresses of servers (to-be-handled servers) to be handled by the address request section 54 and the transfer-determining section 55 in the form of a list.

Referring again to FIG. 14, the functions of the Notify controller 501 will be described.

The searcher 53a refers to the to-be-handled server list 50b, and when a destination address contained in a Notify message is not included in the to-be-handled server list 50b, the searcher 53a transfers the Notify message to a server with the destination address without sending the Notify message to the address request section 54.

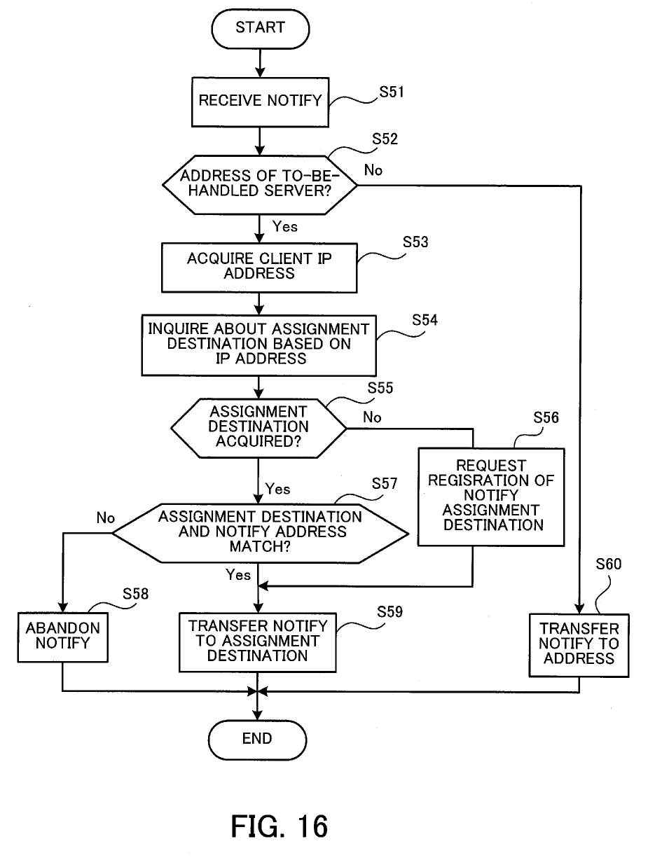

FIG. 16 is a flowchart of a process performed by the Notify controller according to the second embodiment.

First, the Notify receiver 51 receives a Notify message (step S51).

Then, the searcher 53a determines whether or not a destination address contained in the Notify message is the address of a to-be-handled server (step S52). More specifically, the searcher 53a refers to the to-be-handled server list 50b, and determines whether or not the address contained in the Notify message is included in the to-be-handled server list 50b.

If the destination address of the Notify message is one of the addresses of the to-be-handled servers, i.e. if the destination address of the Notify message is included in the to-be-handled server list 50b (Yes to step S52), the process proceeds to a step S53.

In steps S53 to S59, the transfer-determining section 55 carries out processing similar to the processing in steps S12 to S18 in FIG. 9.

On the other hand, if the destination address of the Notify message is not any of the addresses of the to-be-handled servers, i.e. if the destination address of the Notify message is not included in the to-be-handled server list 50b (No to step S52), the searcher 53a transfers the Notify message to a server with the destination address of the Notify message without sending the Notify message to the address request section 54 (step S60).

This completes the description of the process.

According to the Notify controller 501 of the second embodiment, it is possible to obtain the same advantageous effects as provided by the Notify controller 50 according to the first embodiment.

Further, according to the Notify controller 501 according to the second embodiment, when the address of a server which is not included in the to-be-handled server list 50b (e.g. a server which is not a load-distributed server to which the HTTP load balancer 30 distributes load) is contained as a destination address in a Notify message, it is possible to cause he Notify message to be necessarily transmitted to the server. This makes it possible to reduce load on processing by the Notify controller 501. Further, it is possible to prevent the Notify message from being erroneously abandoned.

Although in the present embodiment, servers to be handled are stored in the to-be-handled server list 50b, this is not limitative, but the Notify controller 501 may be configured such that e.g. when servers other than load-distributed servers may be formed into a list, and if an address of a server included in the list is contained as a destination address in a Notify message, the Notify message may be caused to be necessarily transmitted to the server.

### [c] Third Embodiment

Next, a description will be given of a network system according to a third embodiment.

In the following, a description will be mainly given of different points from the first embodiment, and description of elements identical or similar to those described in the first embodiment is omitted.

The network system according to the third embodiment is provided for managing assignment destinations using user IDs, and is distinguished from the first embodiment in the details of an assignment destination management table provided in the HTTP load balancer 30 and the functional configuration of a Notify controller.

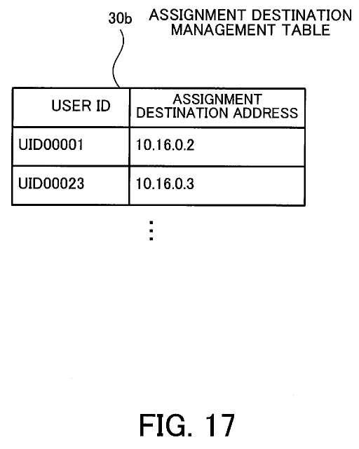

FIG. 17 illustrates the assignment destination management table according to the third embodiment.

The assignment destination management table 30b has a “USER ID” column and an “ASSIGNMENT DESTINATION ADDRESS” column, and pieces of information arranged in each row of the table are associated with each other.

The column of “USER ID” stores information (user ID) for identifying a user currently logged in to a client.

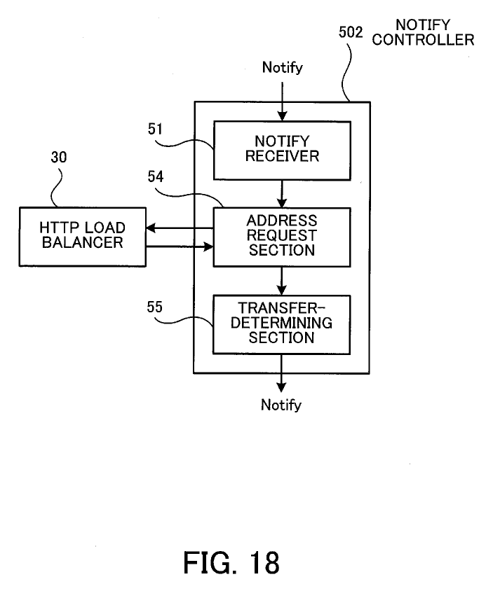

FIG. 18 is a functional block diagram of the Notify controller according to the third embodiment.

The Notify controller 502 does not include the management table storage section 52 or the searcher 53. The address request section 54 directly obtains a Notify message received by the Notify receiver 51. More specifically, the Notify controller 502 according to the present embodiment does not perform processing for identifying a client according to the URI of a tag reader.

The address request section 54 inquires of the HTTP load balancer 30 as to an assignment destination based on a user ID included in tag information in place of a client IP address.

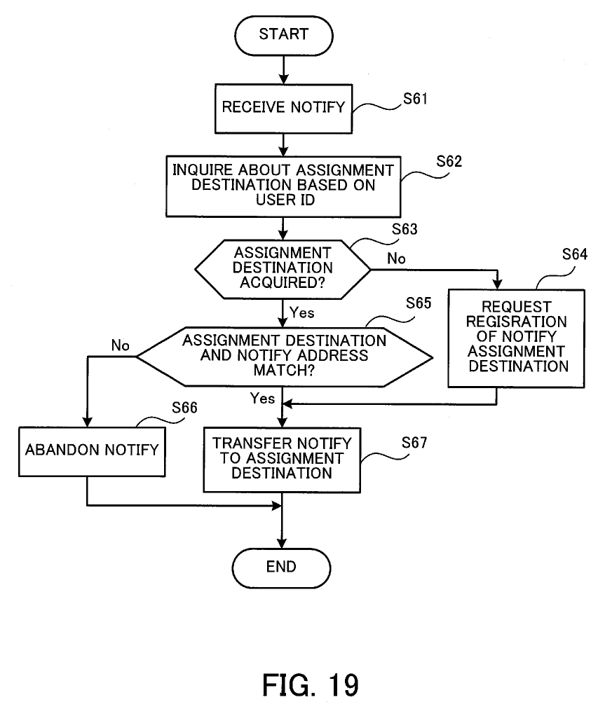

FIG. 19 is a flowchart of a process performed by the Notify controller according to the third embodiment.

First, the Notify receiver 51 receives a Notify message (step S61).

Next, the address request section 54 inquires of the HTTP load balancer 30 as to an assignment destination based on a user ID included in tag information in the Notify message (step S62).

In steps S63 to S67, the transfer-determining section 55 carries out processing similar to the processing in the steps S14 to S18 in FIG. 9, respectively. In the present embodiment, upon reception of the inquiry concerning the assignment destination from the address request section 54, the HTTP load balancer 30 refers to the assignment destination management table 30b to thereby identify an assignment destination server, based on the user ID contained in the inquiry.

According to the Notify controller 502 in the third embodiment, it is possible to obtain the same advantageous effects as provided by the Notify controller 50 of the first embodiment.

Although in the present embodiment, a user ID is used as a notification parameter from the HTTP load balancer 30 and the presence server 40, this is not limitative, but any other suitable parameter, such as a session ID given to an HTTP browser, may be used.

### [d] Fourth Embodiment

Next, a description will be given of a network system according to a fourth embodiment.

In the following, a description will be mainly given of different points from the first embodiment, and description of elements identical or similar to those described in the first embodiment is omitted.

The network system according to the fourth embodiment is distinguished from the first embodiment in that it includes an authentication server for authenticating users, and in the functional configuration of a Notify controller.

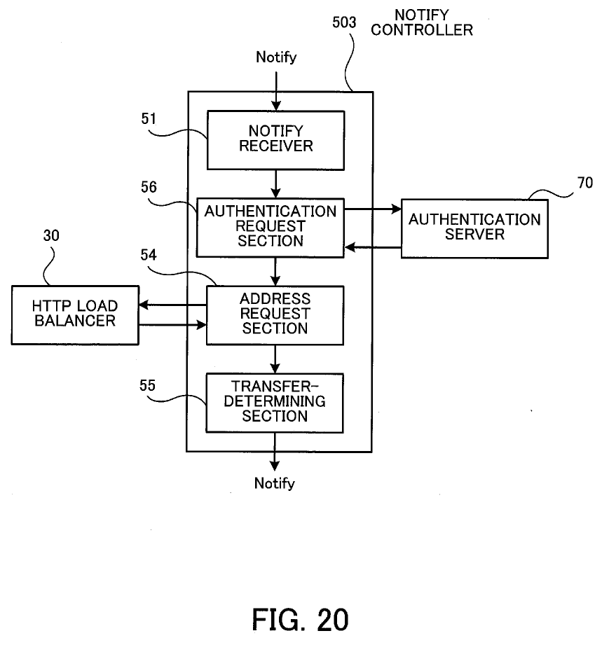

FIG. 20 is a block diagram of the Notify controller according to the fourth embodiment.

The Notify controller 503 in the fourth embodiment includes an authentication request section 56 in place of the management table storage section 52 and the searcher 53.

The authentication request section 56 requests the authentication server 70 to authenticate a Notify message received by the Notify receiver 51 based on a user ID included in tag information in the Notify message.

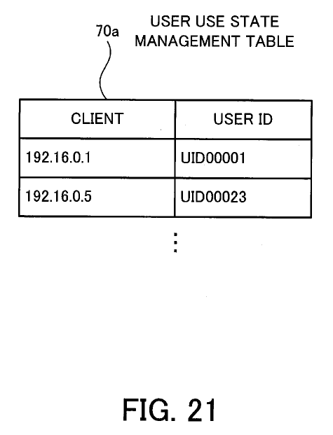

FIG. 21 illustrates a user use state management table included in the authentication server.

The user use state management table 70a has columns of “CLIENT” and “USER ID”, and pieces of information arranged in each row in the table are associated with each other.

The “USER ID” column stores user IDs for permitting a user to log in to a client.

Upon reception of a request from the authentication request section 56, the authentication server 70 returns an IP address of an associated client if the IP address exists, whereas if the IP address does not exist, the authentication server 70 returns a message to the effect that there is no associated client.

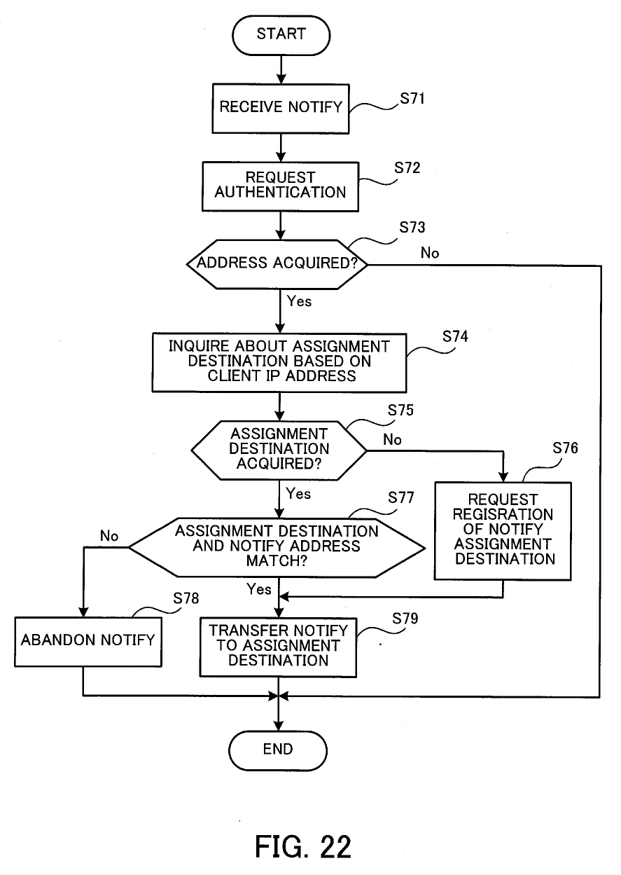

FIG. 22 is a flowchart of a process performed by the Notify controller according to the fourth embodiment.

First, the Notify receiver 51 receives a Notify message (step S71).

Next, the authentication request section 56 requests the authentication server 70 to authenticate the Notify message received by the Notify receiver 51 based on a user ID included in tag information in the Notify message (step S72).

Then, the authentication request section 56 determines whether or not an address of a client is acquired (step S73).

If the address of the client is not acquired, the present process is terminated.

If the address of the client is acquired, the process proceeds to step S74.

In steps S74 to S79, the transfer-determining section 55 carries out processing similar to the processing in the steps S13 to S18 in FIG. 9, respectively.

According to the Notify controller 503 in the fourth embodiment, it is possible to obtain the same advantageous effects as provided by the Notify controller 50 of the first embodiment.

Although in the present embodiment, a user ID is used for authentication of a Notify message, this is not limitative, but for example, a certificate ID acquired from the authentication server 70 may be stored in a tag to cause the tag to be read by the tag readers 20a and 20b, so as to be stored in a Notify message.

It should be noted that the processing functions described above can be realized by a computer. To this end, there is provided a program describing the details of processing of the functions which the Notify controllers 50, 501, 502, and 503 have. By executing the program on the computer, the processing functions described above are realized on the computer. The program describing the details of processing can be recorded in a computer-readable recording medium. Examples of the computer-readable recording medium include a magnetic recording device, an optical disk, a magneto-optical recording medium, and a semiconductor memory. Examples of the magnetic recording device include a hard disk drive (HDD) a flexible disk (FD), and a magnetic tape. Examples of the optical disk include a DVD (Digital Versatile Disk), a DVD-RAM (Random Access Memory), a CD-ROM (Compact Disk Read Only Memory), and a CD-R (Recordable)/RW (ReWritable) Further, the magneto-optical recording medium includes an MO (Magneto-Optical disk), for example.

To make the program available on the market, portable recording media, such as DVD and CD-ROM, which store the program, are sold. Further, the program can be stored in a storage device of a server computer connected to a network, and transferred from the server computer to another computer via the network.

When the event control program is executed by a computer, the program stored e.g. in a portable recording medium or transferred from the server computer is stored into a storage device of the computer. Then, the computer reads the program from the storage device of its own and executes processing based on the program. The computer can also read the program directly from the portable recording medium and execute processing based on the program. Further, the computer may also execute processing based on a program which is transferred from the server computer whenever the processing is to be carried out.

According to the disclosed event control program, no notification request is transferred to any servers other than servers notified as assignment destination servers, which makes it possible to reduce processing load on the other servers.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention have been described in detail, it should be understood that various changes, substitutions, and alterations could be made hereto without departing from the spirit and scope of the invention.

What is claimed is:

1. A computer-readable storage medium storing an event control program that causes an event controller to carry out relay control of events,
the event control program causing the event controller to function as:
a receiving unit configured to receive an event notification request containing designation information designating a client;
a request unit configured to request notification of one of a plurality of servers as an assignment destination server, based on the designation information, the one providing a service to the client identified by the designation information; and
a transfer unit configured to transfer the event notification request to the assignment destination server notified in response to the request by said request unit.

2. The event control program according to claim 1, wherein said receiving unit receives the notification request from a presence server,
wherein said request unit requests a distribution processing apparatus to perform the notification, and
wherein the servers are application servers.

3. The event control program according to claim 1, wherein the event notification request contains a destination address of a server that requests notification of the event, and
wherein said transfer unit transfers the event notification request to the assignment destination server only when the notified assignment destination and the destination address match.

4. The event control program according to claim 1, wherein the designation information is information other than identification information of the client,
wherein the event control program causes the event controller to function as:
a storage unit configured to store the designation information and the identification information of the client in association with each other; and
a search unit configured to search for the identification information of the client from said storage unit according to the designation information contained in the event notification request, when the event notification request is received by the receiving unit, and
wherein said request unit requests notification of the assignment destination server, based on the identification information of the client found by said search unit.

5. The event control program according to claim 1, wherein said request unit requests a load distributor to notify the assignment destination server, the load distributor having a function of distributing load on the servers, and storing information on a server which has established a session with the client.

6. The event control program according to claim 5, wherein when there is no assignment destination server based on the designation information, the load distributor selects an assignment destination server from a predetermined list, and responds to said request unit.

7. The event control program according to claim 1, wherein the event notification request contains a destination address of a server requesting the notification of events,
wherein when said request unit is not notified of the assignment destination server from a requested entity which said request unit requests to notify the assignment destination server, said request unit requests the requested entity to register the destination address according to the designation information.

8. The event control program according to claim 4, wherein the event notification request contains a destination address of a server requesting the notification of events,
wherein said storage unit stores a list that stores identification information on servers to be handled, and
wherein when the destination address is included in the list, said search unit transfers the event notification request to the server included in the list by a first protocol without requesting notification of the assignment destination server.

9. The event control program according to claim 1, wherein said receiving unit receives the event notification request transmitted by a first protocol,
wherein said request unit requests the notification of the server providing the service to the client designated by the designation information by a second protocol, as the assignment destination server, and
wherein said transfer unit transfers the event notification request by the first protocol.

10. An event control method of causing an event controller including a receiving unit, a request unit, and a transfer unit, to carry out relay control of events, comprising:
causing the receiving unit to receive an event notification request containing designation information designating a client;
causing the request unit to request notification of one of a plurality of servers as an assignment destination server, based on the designation information, the one providing a service to the client identified by the designation information; and
causing the transfer unit to transfer the event notification request to the assignment destination server notified in response to the request by the request unit.

11. An event controller that carries out relay control of events, comprising:
a receiving unit configured to receive an event notification request containing designation information designating a client;
a request unit configured to request notification of one of a plurality of servers as an assignment destination server, based on the designation information, the one providing a service to the client identified by the designation information; and
a transfer unit configured to transfer the event notification request to the assignment destination server notified in response to the request by said request unit.
